(19) United States
(12) Patent Application Publication
(10) Pub. No.: US 2010/0051532 A1
(43) Pub. Date: Mar. 4, 2010

(54) TANK

(75) Inventors: Andreas Wawrla, Widnau (CH); Kurt Wallerstorfer, Strasswalchen (AT)

Correspondence Address: William D Breneman;Breneman & Georges, 3150 Commonwealth Avenue, Alexandria, VA, 22305, US

(73) Assignee: AQUIS WASSER-LUFT-SYSTEME GMBH, LINDAU, ZWEIGNIEDERLASSUNG REBSTEIN, Rebstein (CH)

(21) Appl. No.: 12/312,037

(22) PCT Filed: Oct. 18, 2007
(86) PCT No.: PCT/EP2007/009038

§ 371 Date: Jul. 1, 2009

(30) Foreign Application Priority Data
Oct. 23, 2006 (DE) 10 2006 050 302.3

(51) Int. Cl. B01D 27/08

(52) U.S. Cl. 210/236; 210/232

(57) ABSTRACT

The present invention relates to a tank for water-bearing appliances, in particular domestic appliances such as beverage machines, in particular coffee machines, drinking water dispensers, cooking and baking appliances, steam appliances, in particular steam irons, steam cleaners, pressure washers, air purifiers and conditioners or the like, having a filter cartridge connection (8). Said tank is distinguished in that an appliance connection (3), which can be connected with a predominantly horizontal insertion movement, is connected to connection elements which are provided for a filter cartridge (2) which can be inserted into the inside of the tank (1).

The present invention also relates to a filter for use with a water tank of this kind and an appliance in which a water tank of this kind can be employed.

The invention relates to a tank having a filter cartridge according to the preamble of claim 1.

In various machines, for example in coffee or espresso machines, a water tank is provided for storing a liquid, in the case of coffee or espresso machines for storing water, it being possible for a filter cartridge to be inserted into the tank in order to prepare the water before it is processed in the machine. Known filter cartridges have, in the lower region, an inlet through which the water is drawn by the associated machine. In the process, the water is conducted over a filter bed and enters the machine via a connection of the filter cartridge at a corresponding appliance connection of the water tank which is often in the form of a suction connection.

This appliance connection of the water tank is generally formed in the base in commercially available embodiments. This results firstly in easy emptying of the tank and secondly a tank of this kind, which is generally injection-molded from plastic, can be produced in a relatively cost-effective manner by simply shaping the required injection molding means. Installation of filters for providing water which is correspondingly prepared for operation of the machine, for example in the form of plug-in filters, can also be realized in an uncomplicated and cost-effective manner in this case.

For servicing purposes, embodiments of this kind can be removed from the appliance in question in the upward and/or sideways direction and can be reinserted in the opposite direction. On account of the often restricted conditions for operation of the machine and/or for accommodating the tank on the machine, these embodiments can therefore often be used only to an insufficient extent.

On the other hand, it is highly important for reliable operation of the machine for a filter cartridge which has defined filter parameters to be used. With a faulty filter cartridge, the machine is supplied with an insufficient amount of water or water which has been incorrectly prepared, and this can lead to negative effects, for example to the formation of limescale or the like, or even to machine defects. The machine control system is not able to initiate the intended servicing intervals at the correct time, as when a filter cartridge of the correct type has been used, if the correct type of filter cartridge is not actually used. The use of inadequate filter cartridges leads to problems not only with the operational reliability of the machine but also raises questions regarding the guarantee etc. It is therefore highly important to always ensure that only permissible filter cartridges are used.

The invention is therefore based on the problem of improving a tank and a filter cartridge of the type described in the introduction.

Accordingly, a tank for liquid-bearing appliances, in particular water-bearing domestic appliances such as beverage machines, in particular coffee machines, drinking water dispensers, cooking and baking appliances, steam appliances, in particular steam irons, steam cleaners, pressure washers, air purifiers and conditioners or the like, having a filter cartridge connection is distinguished in that an appliance connection, which can be connected with a predominantly horizontal insertion movement, is connected to connection elements which are provided for a filter cartridge which can be inserted into the inside of the tank.

As a result, it is possible, for example, to create a so-called “drawer-type tank” with a side connection between the machine and the tank which, in particular in a space-saving manner, can be inserted into the appliance for the purpose of providing the required water and, respectively, can be removed again from the front or from a preferred side for refilling and/or servicing purposes.

In a preferred embodiment, the tank-side filter cartridge connection and/or a filter-side tank connection have/has a run-off edge which defines a plane which is oriented in an inclined manner in relation to a plane which is vertical in the operating state of the water storage tank.

The arrangement of the corresponding filter with an inclined connection or inclined sealing surface in a tank which is formed in this way actually overcomes several problems since handling of the filter normally requires a certain amount of practice and fine motor skills for insertion and removal purposes on account of an angled connection geometry. However, due to the inclined geometry, according to the invention, of the tank- and filter cartridge-side connections and a sealing surface, which is situated and/or formed between them and at the same time is highly position-tolerant, the filter cartridge can be plugged on, as in the case of base-side tank outlets, in a simple manner horizontally or vertically. However, a pivoting movement for inserting and removing the filter cartridge by means of a corresponding mount and/or guide is also highly suitable for this purpose.

In a preferred embodiment, the tank-side filter cartridge connection can, for this purpose, be formed at an edge between a side wall and the base of the tank in such a way that it forms a run-off edge which connects said side wall and base to one another and lies in an inclined plane, for example in an angular range of from 30° to 60°.

It is particularly advantageous when the lowest point of the run-off edge ends as close as possible to the base of the tank, so that this produces a unusable dead water quantity in the tank volume which is as low as possible, preferably none at all, even when the predominantly horizontally oriented appliance connection of the water tank is formed on the side of a tank wall. However, it is not absolutely necessary in this case for base and/or side walls to have an exactly rectangular orientation in a Cartesian coordinate system. Depending on the application, these may well themselves have certain inclinations relative to the horizontal or to the vertical, in order, for example, to allow better outflow of water and/or better matching to physical conditions.

A further advantage of such an inclined orientation of the tank and filter cartridge connections and of the sealing surface situated between them is that the filter cartridge can be mounted or removed with a predominantly straight, substantially perpendicular insertion or withdrawal movement in order to be inserted into the tank and removed from the tank again. A filter cartridge mount and/or filter cartridge guide with a predominantly vertically oriented guide section is particularly advantageously proposed for this purpose. This ensures exact and defined placement of the filter-side tank connection on the tank-side filter cartridge connection.

In order to additionally facilitate fitting of the filter cartridge, the filter cartridge mount and/or filter cartridge guide may have a centering section in the insertion region, so that the complementary fixing structure which is formed on the filter cartridge is fundamentally “self-catching”.

In order to permit good abutment between the filter-side tank connection and the tank-side filter connection, in particular for providing a sealing surface which is oriented in an inclined manner, the invention further proposes forming a planar abutment surface on the tank-side filter cartridge connection. Such a planar abutment surface, which is oriented in an inclined manner in relation to the insertion movement, has particularly position-tolerant properties since a predominantly parallel, relative displacement movement occurs when the filter-side tank connection makes contact with this planar contact surface during the substantially vertical insertion movement of the filter. As a result, a substantially uniform contact pressure can be achieved over the entire circumference of the contact surface, even when the two contact surfaces are displaced relative to one another. However, a non-planar sealing surface which can likewise be arranged to be oriented in an inclined manner is also feasible in principle.

The filter-side tank connection particularly preferably also has such a planar abutment surface, in particular for forming a sealing surface, and especially preferably also with the same inclined orientation. Therefore, a first embodiment of a seal between the tank-side filter cartridge connection and the filter-side tank connection can be provided in a manner which is particularly simple to produce, simple to service and nevertheless acts in a reliable fashion.

This sealing effect can be improved using simple measures by at least one elastically deformable region being formed on one of the two abutment surfaces, which are preferably realized as sealing surfaces, preferably with a slight prestress relative to its complementary abutment surface of the respectively other connection. As a result, the surface region in question can be prestressed in a sealing manner solely by the weight of the filter cartridge and/or by a contact pressure which is possibly created by fixing of the filter cartridge.

In an embodiment which is somewhat superior to the above, it is also feasible to use an additional seal, in the case of which at least one elastically deformable section is likewise particularly preferably provided. As a result, the seal can particularly advantageously press against its associated abutment surface even more forcefully by means of a suction action during operation of the filter, so as to improve its sealing effect. Such an elastically deformable section may be, for example, a ring which is approximately lip-like in the cross section of the seal and bears, for example, against its outer edge region and on account of which its effective sealing surface increases in size compared to the abutment surface due to a vacuum generated in the interior of the outflow region. A so-called “V-seal” may be mentioned as an exemplary embodiment here. On account of these seal embodiments which are oriented in an inclined manner, an axial seal which is particularly simple to handle can be realized, said axial seal being highly fault-tolerant with regard to exact positioning of the two sealing components in relation to one another.

A tank-side filter cartridge connection for a filter-side tank connection could also be realized by means of a radial seal. To this end, for example two connection elements, which are oriented coaxially to one another at least in a short region, of the tank-side filter cartridge connection and of the filter-side tank connection could be sealed off from one another. In a first possible embodiment, a lip which faces the complementary pipe section and is preferably likewise formed to be somewhat elastic could, for example, likewise be provided for this purpose. In another embodiment, it is also feasible to use an O-ring which is positioned between these two connection sections which are oriented coaxially to one another. A filter cartridge mount and/or filter cartridge guide which is provided for this purpose could likewise substantially have a predominantly vertically oriented guide section which, however, could possibly experience superimposition of the substantially perpendicular guide movement with a transverse movement at the end of the guide section in order to guide the coaxial connection sections one into the other, if required.

For both embodiments of filter cartridge mounts and/or filter cartridge guides, fixing of the filter cartridge in an end position can additionally be provided, for example realized by a snap-action mechanism or the like.

In addition, any types of seals comprising foam rubber are suitable for use for the above-described radial or axial seals.

A further possible embodiment for the seal may be realized by forming an interlocking connection between the tank-side filter cartridge connection and the filter-side tank connection, as partly already described above by the two planar abutment surfaces on the tank- and filter-side connections. However, an element which borders the run-off edge, which is oriented in an inclined manner, of the tank-side filter cartridge connection, for example in the form of a cylinder, in the form of a triangle, in the form of a rectangle, a polygon or the like, is also feasible. The surfaces which face the complementary interlocking element preferably have a slightly conical orientation, so that a reinforcing clamping effect is produced between the respective abutment surfaces, particularly preferably with a sealing action, when said surfaces are joined as movement progresses.

In order to ensure that only filter cartridges which are intended for the respective water-bearing appliance are used with this tank, the invention further preferably proposes a mechanical coding structure between the tank-side filter cartridge connection and the filter cartridge and/or the seal. However, a coding structure of this type could also be formed between the seal and the filter cartridge. The coding structure itself may be formed, for example in a first embodiment, as a tooth system, so that only teeth which correspondingly match one another or corresponding cutouts permit correct fixing of the filter cartridge in the tank. The above-described interlocking connection between the tank-side filter cartridge connection and the filter-side tank connection is also highly suitable as a mechanical coding structure. Therefore, the filter-side tank connection can be provided both as a coding structure and as a molded seal with a correspondingly formed circumferential surface.

On account of the coding, it is further possible, in specific applications, to assign cartridges with filters which are provided especially for them. For example, various softening stages and/or the admixture of possibly additional additives, for example the admixture of nutritional supplements, for example in the form of vitamin C or the like, can be provided for various appliances. The provision of an active carbon filter in the filter cartridge can also be influenced by a coding of this type. Incorrectly coded or uncoded filter cartridges can therefore be prevented from operating with the tank.

In a particularly preferred embodiment, the coding structure can also be provided at least partially simultaneously in the form of a fixing element for mounting the filter cartridge. This is particularly advantageously possible in the case of the above-described interlocking connection.

In order to be able to use the volume of the tank in as optimum a manner as possible, the invention proposes that a water inlet be formed on the filter cartridge, in which case an inlet opening is provided in the housing of the filter cartridge level with the empty level of the tank, through which inlet opening the water enters the filter cartridge. If the filter cartridge itself reaches the base of the tank in the operating state, the water tank can be virtually completely emptied, with the precondition that a corresponding inflow option, for example in the form of inflow channels or the like, to the water inlet of the filter cartridge is provided.

For filtering purposes, it is considered particularly preferred when a filter section which is active in the upward-flow method and/or a downward-flow method is provided. The arrangement of a partition wall in the interior of a corresponding filter housing is, in particular, exceptionally suitable as a basic precondition for this method. In the case of such division, it is, for example, also easily possible to fill the filter, in accordance with the respectively intended application, with different filter materials and/or additives. By varying the position of the partition wall in the interior of the housing or the respective volume ratio, it is also possible, for example, to provide a respectively corresponding volume for a specific filter material, with multi-chamber division in the interior of the filter housing also being possible for the purpose of providing a plurality of preferably different filter sections.

However, horizontal- and/or tangential-flow filter methods, possibly also in combination with upward-flow and/or downward-flow methods, are also feasible.

In addition to the tank described up to this point, the present invention also relates to a filter for use in a tank for water-bearing appliances in accordance with one or more of the above-described embodiments, which filter is distinguished in that a filter-side tank connection which is designed to connect said filter to the tank-side filter cartridge connection is provided.

In addition, the present invention also relates to an appliance, in particular a water-bearing domestic appliance or an appliance for preparing food and/or beverages, such as beverage machines, in particular coffee machines, drinking water dispensers, cooking and baking appliances, steam cleaners and/or pressure washers, air purifiers and conditioners or the like, having a tank, which appliance is distinguished in that the tank is designed as claimed in one of the abovementioned features.

### EXEMPLARY EMBODIMENT

The present invention is explained in greater detail below with reference to the figures and the description which refers to said figures, in which

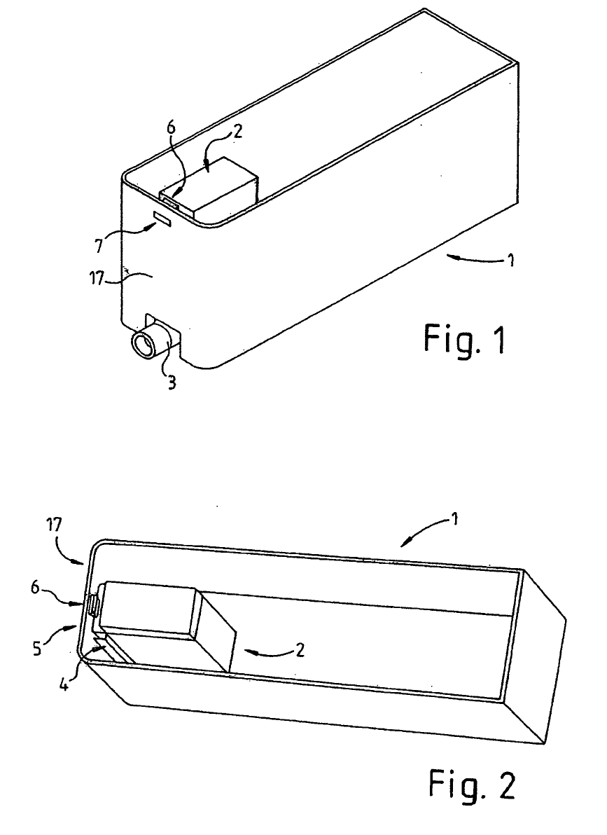

FIG. 1 schematically shows a perspective view of a tank for water-bearing appliances, in particular domestic appliances, having a horizontally oriented appliance tank connection and a filter cartridge which is inserted into the tank in the vertical direction,

FIG. 2 schematically shows a perspective plan view of the arrangement from FIG. 1,

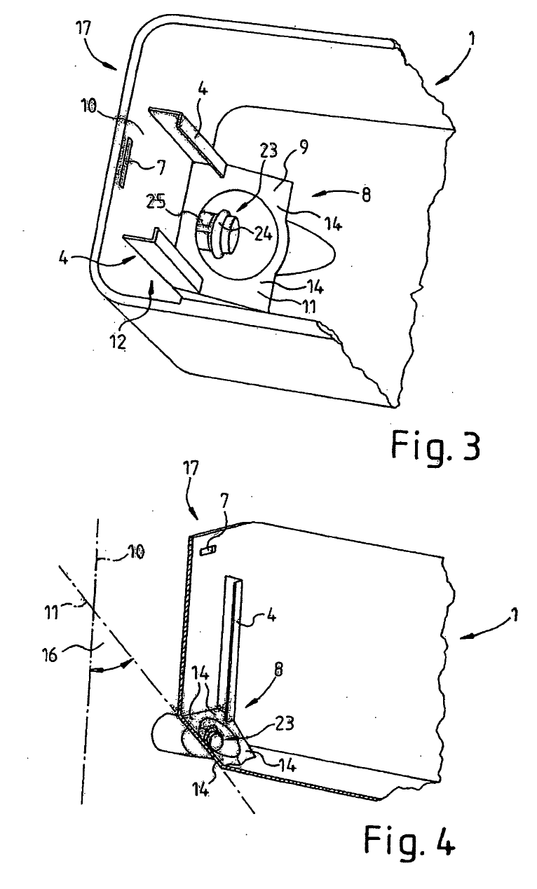

FIG. 3 shows an enlarged illustration of a first embodiment of the tank according to FIG. 2 with the filter cartridge removed and a tank-side filter cartridge connection arranged in said tank,

FIG. 4 schematically shows a perspective view of a sectional illustration along a longitudinal section of the tank from below, with the front wall omitted,

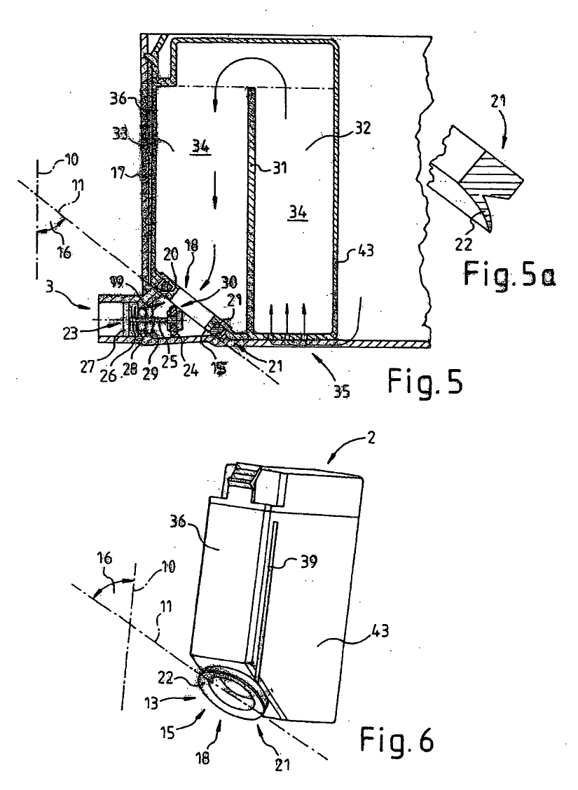

FIG. 5 schematically shows a longitudinal sectional illustration through a detail of the arrangement according to FIG. 1,

FIG. 5a schematically shows a cross section through a seal which is shown in FIG. 5,

FIG. 6 schematically shows a perspective view of a filter cartridge,

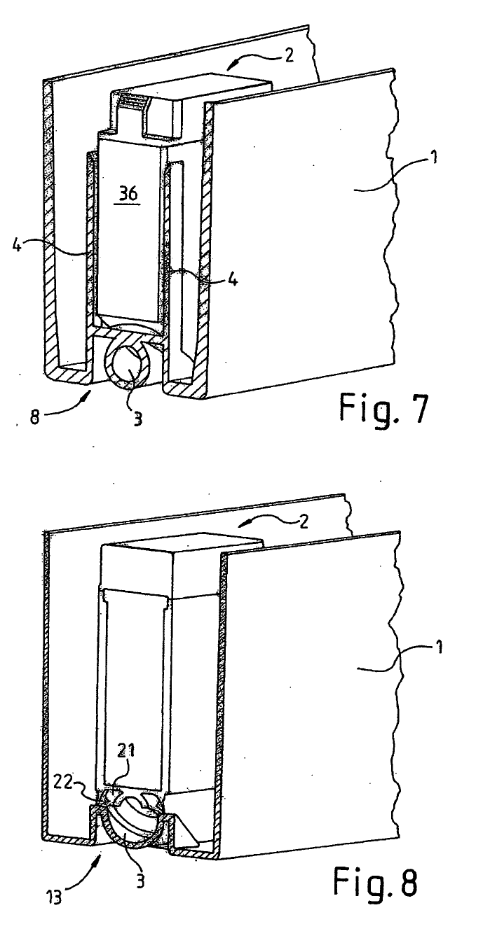

FIGS. 7+8 each show further sectional illustrations of the tank and of the filter according to FIG. 1 in different views,

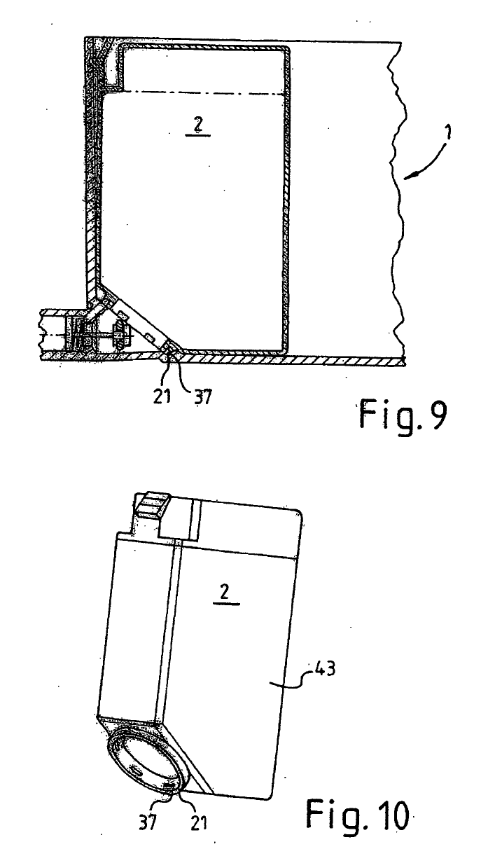

FIGS. 9+10 show further illustrations according to FIGS. 5 and 6, but with an embodiment, which is modified compared to said FIGS. 5 and 6, of a seal in the form of an O-ring,

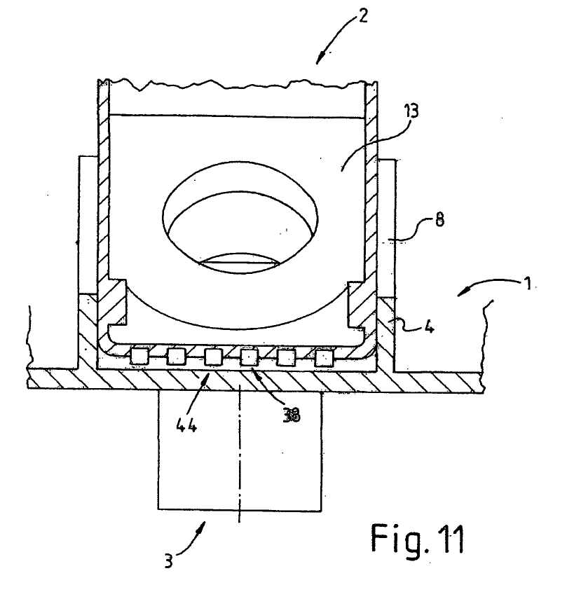

FIG. 11 schematically shows a plan view of the detail of a mounting and coding region between the tank and the filter cartridge,

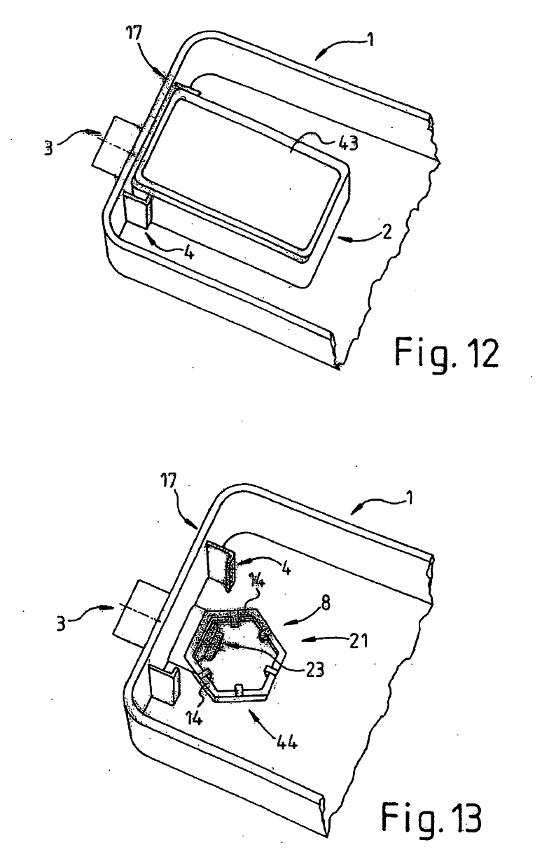

FIGS. 12-17 show a further embodiment of a water tank and an associated filter cartridge with a tank-side filter cartridge connection which is modified compared to the first embodiment, and a modified tank connection in different schematic illustrations, and

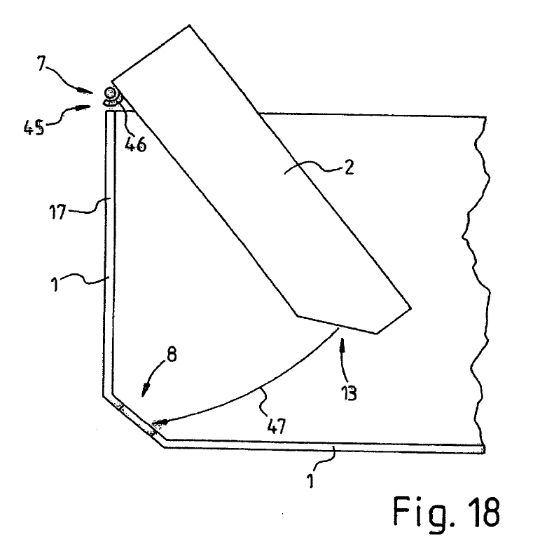

FIG. 18 shows a further sectional illustration of a detail of a possible embodiment of a filter cartridge mount and/or guide or mounting option.

Accordingly, FIG. 1 schematically shows a perspective plan view of a tank 1 for water-bearing appliances, in particular domestic appliances, having a filter cartridge connection 8 (FIG. 3) and a predominantly horizontally oriented appliance connection 3. Tanks of this kind are also called “drawer-type tanks” and are preferably provided for use in areas with restricted space conditions. One advantage of such drawer-type tanks is that they can be inserted into the appliance in question and can be removed from said appliance from the front. The connection to the water-processing unit of the appliance is generally, but not necessarily, established via a suction connection line to which the appliance connection 3 is connected so as to conduct water and be sealed off from the outside when the tank 1 is inserted into the appliance (not illustrated).

FIG. 2 schematically shows a perspective plan view of how the filter cartridge 2 is mounted on the tank 1 by means of a filter cartridge mount and/or guide 4. This filter cartridge mount and/or guide is in the form of two rails which are arranged substantially vertically on the end wall 5. Also shown is a fixing means 6 which latches, preferably in a spring-elastic manner, into a recess 7 in the end wall 5 when the filter cartridge 2, for example in the form of a snap-action mechanism, is in the fully inserted state.

FIG. 3 shows a perspective plan view of the filter 1 with a tank-side filter cartridge connection 8 which, according to the invention, has a run-off edge 9 which is oriented in an inclined manner in relation to the vertically oriented end wall 5.

As a result, the filter cartridge 2 can be inserted into the tank 1 along the vertically oriented guide section 12 by way of a simple insertion movement until effective abutment is achieved between the tank-side filter connection 8 and the filter-side tank connection 13 (FIG. 6). In order to improve the effective abutment, and in particular in order to form a sealing surface 42 which is oriented in an inclined manner, the tank-side filter cartridge connection has a planar abutment surface 14. In order to provide a particularly effective abutment or sealing function between the two connection elements, the filter-side tank connection 13 can particularly preferably also have a planar abutment surface 15. These two planar abutment surfaces 14, 15 have a high degree of positional tolerance since they are also leaktight when the two water passages of the tank-side filter cartridge connection and of the filter-side tank connection which correspond to one another are not positioned exactly one above the other but possibly are displaced parallel to one another in the plane which runs through the two surfaces.

The planar abutment surface 15 of the filter-side tank connection 13 can be realized with different surfaces depending on the design of the filter cartridge. In a first embodiment, it is feasible for this planar abutment surface 15 to be formed directly by the end face 17 of the outlet opening 18 of the filter cartridge 2. In this case, it is necessary for this end face 17 to have such a large, flat extent so that it can ensure sufficient coverage in each position when the filter cartridge 2 is inserted and in the case of a parallel offset, which occurs in the process, between the outlet opening 18 and the corresponding outlet opening 19 on the tank-side filter cartridge connection. This applies particularly to those embodiments in which the planar abutment faces 14, 15 simultaneously seal off this region, possibly with an elastically deformable, preferably lip-like, abutment region. A lip-like abutment region of this type could possibly also have a certain prestress and be formed such that it is directed slightly in the opposite direction to its complementary other planar abutment surface. As a result, it is possible to increase the sealing effect by contact pressure when the filter cartridge is fixed.

In an embodiment which is modified compared to the above, it is also feasible for the planar abutment face 15 of the filter-side tank connection 13 to be formed by a shoulder 20 which borders the outlet opening 18. It is also true of this planar surface that it is so large that a sufficiently large degree of coverage of its abutment region by the abutment region of the planar abutment surface 14 of the tank-side filter cartridge connection 8 is ensured.

However, in a further embodiment, it is also possible to provide a seal 21 between the tank-side filter cartridge 8 and the filter-side tank connection 13, this seal either bearing against such a planar abutment surface itself or being able to form such a planar abutment surface, preferably again in combination with a slightly prestressed additional seal section 22 which is designed to be oriented such that it slightly comes to meet the complementary abutment face (FIGS. 5 and 5a).

FIG. 4 shows a sectional illustration along a longitudinal section through the tank 1. This section runs approximately in the center of the left-hand edge and lower edge of the tank-side filter cartridge connection 8 in the illustration of FIG. 3. The valve 23 of the tank-side appliance connection 3 and its seal 24 and its shaft 25 can be clearly seen in the two figures.

In order to better illustrate the inclined orientation of the tank-side filter cartridge connection 8 relative to the vertical plane 10, FIGS. 4 to 6 have representative lines 10 and 11 which form between them an angle 16 corresponding to the respective inclined orientation of these two surfaces relative to one another.

FIG. 5 shows a further return element 26 for the valve 23, by way of example in the form of a helical spring in this case. This helical spring is arranged between a valve-side stop in the form of a fluid-permeable ring 27 and a tank outlet-side stop 28, so as to surround the shaft 25. When the tank is inserted into the appliance (not illustrated), a pin can, for example, press against the ring, so that the valve 23 is moved into the position illustrated here and the seal 24 is lifted away from the sealing seat 29 in order to allow the water flowing out of the filter cartridge in the direction of the appliance to pass through.

This illustration of FIG. 5 also clearly shows that the outlet opening in the tank-side filter cartridge connection 8 is so large that, in order to mount the valve 23, the valve body with the seal seat 30 can be inserted through the outer opening in the appliance connection 3 in advance such that the seal 24 can be mounted on the seal seat 30 from the inside of the tank. This is a further essential advantage of this arrangement, which is oriented in an inclined manner according to the invention, of the tank-side filter cartridge connection 8 which is therefore designed such that, in addition to this simple valve mounting, it can also be produced in a cost-effective manner with injection molds which are easy to manufacture.

The illustration of FIG. 5 also shows a partition wall 31 for partitioning or dividing the interior of the filter cartridge 2 so that two chambers 32, 33 are formed in the housing interior of the filter cartridge 2. These two chambers 32, 33 can, depending on the desired application, accommodate corresponding filter material, possibly also a combination of filter materials with various filter effects, possibly also supplemented with further additives, for example food additives or the like.

In order to remove the water from the tank 1, an inlet 35 is arranged on the filter cartridge 2 at a lowest possible point in the housing 43 of the filter cartridge 2, said inlet defining the empty level 41 of the tank 1, by way of example in the base region of the filter cartridge housing in this case. By virtue of this low intake point, it is therefore possible to ensure that the water tank is completely emptied when water is removed from the filter tank.

FIG. 5a shows, by way of example, a cross-sectional illustration of a detail of the seal 21 with a lip-like seal section 22 which, in the event of a vacuum prevailing in the interior, presses against its complementary sealing face and thus ensures that the sealing effect of this seal is increased or improved. However, instead of such a “V”-seal, it is also feasible, in principle, for an O-ring to be used for such axial sealing between the tank-side filter cartridge connection 8 and its associated, complementary sealing surface of the filter cartridge 2.

FIG. 6 schematically shows a perspective view of the filter cartridge 2 with a focus on illustrating the filter-side tank connection 13 which is oriented in an inclined manner, the axial seal 21 which is arranged therein, and its sealing lip 22 which is slightly prestressed in the direction of the complementary contact surface.

FIG. 7 shows a further sectional illustration through the tank 1 and the filter cartridge 2, in which the end face 17 of the tank 1 is cut away. FIG. 8 shows a further sectional illustration in which the section according to FIG. 7 is offset further toward the rear into the interior of the tank, so that the relevant end face 36 of the filter cartridge 2 is also cut away and the underlying filter-side tank connection 13 and with its seal 22 are illustrated in section.

FIGS. 9 and 10 correspond, in principle, to the illustrations of FIGS. 5 and 6, except that here the seal 21 is in the form of an O-ring 37.

FIG. 11 schematically shows a plan view of the detail of the connection region of the filter cartridge 2 on the tank 1 with a tank-side filter cartridge connection 8 and a filter-side tank connection 13 from the inside. The essential feature of this illustration is the mechanical coding 38, by way of example in the form of a tooth system in this case. A mechanical coding of this type can ensure that only filter cartridges which are intended for the respective application can be used. However, in addition to a toothed coding, as illustrated by way of example in this case, it is entirely feasible to use other forms of codings in the form of axial and/or radial coding structures. A coding of this type can be formed between the tank-side filter cartridge connection 8 and the filter cartridge 2 and/or the seal 21 or else between the seal 21 and the filter cartridge 2. Combinations of codings of this type are also feasible and increase the total number of possible codings again without a great deal of additional outlay.

It is further feasible for this coding 38 to also function at least partially simultaneously as a fixing element 44 for mounting the filter cartridge 2.

In addition to this first embodiment which is illustrated by way of example, FIGS. 12 to 17 show a further possible design of a tank-side filter cartridge connection with inclined orientation relative to a vertical plane in interaction with a filter-side tank connection 13 which is likewise oriented in an inclined manner. For the sake of simplicity, the same reference symbols as cited in the first embodiment are used for the same components. The essential feature here is the hexagonal form, which is illustrated by way of example, of the tank-side filter cartridge connection 8 in the illustration of FIG. 13 or for the filter-side tank connection 13 in the illustration of FIG. 17 as a perspective view of the filter cartridge 2 from below. These two hexagons 44 engage one in the other in an interlocking and sealing manner when the filter cartridge 2 is inserted into the tank 1 along the filter cartridge mount and/or guide 4. Both an interlocking connection between the two connections and a seal between said connections can thus be realized, and at the same time mechanical coding in a special embodiment can simultaneously also be realized. A coding of this type can also be varied for various applications by modifying this hexagonal contour and/or by adding a further contour.

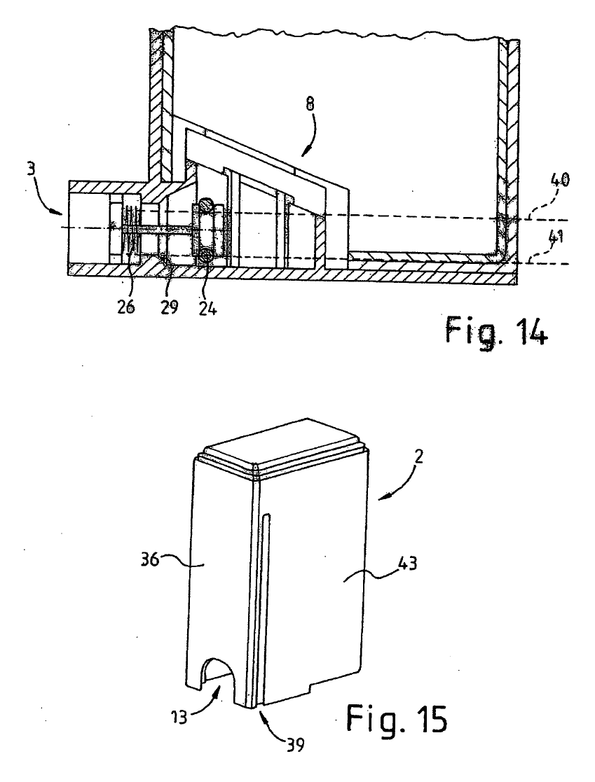

Specifically, FIG. 12 schematically shows a perspective plan view of a tank 1 with a filter cartridge 2 inserted therein, FIG. 13 likewise schematically shows a perspective plan view of a tank 1 but without the filter cartridge 2 inserted, FIG. 14 schematically shows an illustration of a longitudinal section through a detail of this embodiment in accordance with the illustration of FIG. 5.

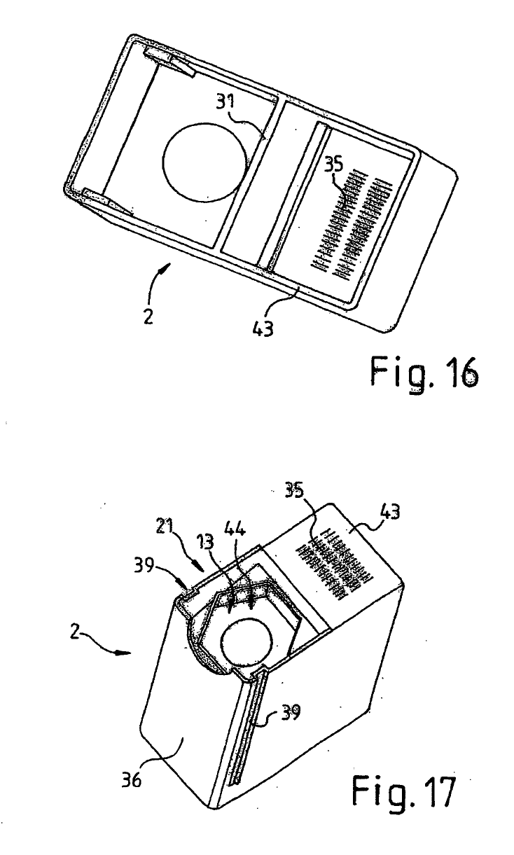

FIG. 15 schematically shows a perspective plan view of a filter cartridge 2, FIG. 16 schematically shows a perspective plan view of a filter cartridge 2 with the cover removed, and with the partition wall 31 and water inlet 35 visible. FIG. 17 schematically shows a perspective view of the filter cartridge 2 according to this second embodiment from below, with a filter-side tank connection which has a hexagonal cross section. In the illustrations of FIG. 15 and FIG. 17, the cartridge-side guide elements 39, in the form of longitudinal grooves in this case, are shown as complementary elements for the filter cartridge mount and/or guide 4 of the tank 1.

The illustration of FIG. 14 shows the possible water level 41 in the tank when said tank is emptied with the filter cartridge inserted, and said water level without the filter cartridge inserted is shown by line 40.

The orientation of the incline relative to a vertical plane can preferably have an angle of from 30 to 60°. However, in order to access the appliance connection 3 from inside the tank, the tank-side filter cartridge connection 8 is preferably so large that the valve body of the valve 23 can be inserted from the outside and the seal 24 can be mounted on its seal seat 30 from the inside. The filter cartridge 2 is preferably fixed in the tank 1 such that when the filter cartridge-side fixing means 6 latches into the end-face recess 7 in the tank 1, a contact pressure which is sufficient to seal off the two complementary abutment surfaces of the tank-side filter cartridge connection 8 and of the filter cartridge-side tank connection 13 is ensured, specifically both with and without a separate intermediate seal 21. A certain bandwidth for a tolerance range is provided for this purpose by the particularly advantageous, inclined orientation of these two connections on account of their geometric properties, this orientation ensuring parallel displacement of the two abutment faces relative to one another, together with reliable sealing.

FIG. 18 shows a further mounting option for the filter cartridge 2 in the tank 1, in the form of a pivotable filter mount and/or guide 45, as a sectional illustration of a detail. This may comprise, for example, a recess 7 in a tank wall 17 and a correspondingly complementarily shaped engagement element 46. By joining these two tank- and filter-side pivoting elements 7, 46, the filter cartridge 2 can be guided sufficiently accurately along the movement curve described by the arrow 47 for connection to the tank 1, which connection is fit for purpose and has already been described in detail above. However, other pivoting structures, for example interchanging the two elements 7 and 46, and/or also forming the pivot point or the pivot axis in the opposite filter cartridge mounting region in the tank 1, for example on the tank base and/or in the connection region 8, 13, are also feasible. However, lateral pivoting-in in accordance with a possibly vertical or horizontal guide movement could also provide a simple and reliable mounting and removal option for the filter cartridge 2.

### LIST OF REFERENCE SYMBOLS

1 Tank

2 Filter cartridge

3 Appliance connection

4 Filter cartridge mount and/or guide

5 End wall

6 Fixing means

7 Recess

8 Filter cartridge connection

9 Run-off edge

10 Vertical plane

11 Plane of the run-off edge

12 Guide section

13 Filter-side tank connection

14 Abutment surface

15 Abutment surface

16 Angle

17 End face

18 Outlet opening

19 Outlet opening

20 Shoulder

21 Seal

22 Seal section

23 Valve

24 Seal

25 Shaft

26 Return element

27 Ring

28 Stop

29 Sealing seat

30 Seal seat

31 Partition wall

32 Chamber

33 Chamber

34 Filter material

35 Inlet

36 End face

37 O-ring

38 Coding

39 Guide

40 Line

41 Line

42 Sealing surface

43 Housing

44 Fixing means

45 Filter cartridge mount and/or guide

47 Arrow

What is claimed is:

1. A tank for liquid-bearing appliances, in particular water-bearing domestic appliances such as beverage machines, in particular coffee machines, drinking water dispensers, cooking and baking appliances, steam appliances, in particular steam irons, steam cleaners, pressure washers, air purifiers and conditioners or the like, having a filter cartridge connection (8), characterized in that an appliance connection (3), which can be connected with a predominantly horizontal connection movement, is connected to connection elements which are provided for a filter cartridge (2) which can be inserted into the inside of the tank (1).

2. The tank as claimed in claim 1, characterized in that the tank-side filter cartridge connection (8) and/or a filter-side tank connection (13) have/has a run-off edge (9) which defines a plane (11) which is oriented in an inclined manner in relation to a plane (10) which is vertical in the operating state of the tank.

3. The tank as claimed in either of the preceding claims, characterized in that the appliance connection (3) of the water tank (1) is oriented predominantly horizontally.

4. The tank as claimed in one of the preceding claims, characterized in that the appliance connection (3) of the water tank (1) is arranged on a side wall (17) of the tank (1).

5. The tank as claimed in one of the preceding claims, characterized in that a filter cartridge mount and/or a filter cartridge guide (4) is provided with a guide section (12) which is oriented predominantly vertically.

6. The tank as claimed in one of the preceding claims, characterized in that a filter cartridge mount and/or filter cartridge guide (45) which imposes a pivoting movement on the filter cartridge (2) for insertion and/or removal purposes is provided.

7. The tank as claimed in one of the preceding claims, characterized in that a sealing surface (42) is provided, this sealing surface being oriented in an inclined manner in relation to a plane (10) which is vertical in the operating state of the tank.

8. The tank as claimed in one of the preceding claims, characterized in that the tank-side filter cartridge connection (8) has a planar abutment surface (14).

9. The tank as claimed in one of the preceding claims, characterized in that the filter-side tank connection (13) has a planar abutment surface (15).

10. The tank as claimed in one of the preceding claims, characterized in that a seal (21) is provided between the tank-side filter cartridge connection (8) and the filter-side tank connection (13).

11. The tank as claimed in one of the preceding claims, characterized in that the seal (21) has at least one elastically deformable section (22).

12. The tank as claimed in one of the preceding claims, characterized in that the seal (21) is in the form of an axial seal.

13. The tank as claimed in one of the preceding claims, characterized in that the seal (21) is in the form of a radial seal.

14. The tank as claimed in one of the preceding claims, characterized in that a mechanical coding structure (38) is provided between the tank-side filter cartridge connection (8) and the filter cartridge (2) and/or the seal (21).

15. The tank as claimed in one of the preceding claims, characterized in that a mechanical coding structure (38) is provided between the seal (21) and the filter cartridge (2).

16. The tank as claimed in one of the preceding claims, characterized in that the coding structure (38) is at least partially simultaneously in the form of a fixing element (44) for mounting the filter cartridge (2).

17. The tank as claimed in one of the preceding claims, characterized in that the tank-side filter connection (8) has a receptacle (44) with a polygonal cross section.

18. The tank as claimed in one of the preceding claims, characterized in that the filter-side tank connection (8) is in the form of a coding structure (38) and in the form of a molded seal (21) with a correspondingly formed circumferential surface.

19. The tank as claimed in one of the preceding claims, characterized in that an inlet opening (35) is provided in the housing (43) of the filter cartridge (2) as a passage for the water from the tank to the filter cartridge.

20. The tank as claimed in one of the preceding claims, characterized in that a filter section (32) which is active in the upward-flow method and/or a filter section (33) which is active in the downward-flow method is provided on the filter cartridge (2).

21. The tank as claimed in one of the preceding claims, characterized in that a filter section which is active in the horizontal-flow method and/or tangential-flow method is provided on the filter cartridge (2).

22. A filter for use with a water tank according to one of the preceding claims, characterized in that a filter-side tank connection (13) which is designed for connection to the tank-side filter cartridge connection (8) is provided.

23. An appliance, in particular a water-bearing domestic appliance or appliance for preparing food and/or beverages, such as beverage machines, in particular coffee machines, drinking water dispensers, cooking and baking appliances, steam cleaners and/or pressure washers, air purifiers and conditioners or the like, having a tank, characterized in that the tank is designed as claimed in one of claims 1 to 21.
